(19) United States
(12) Patent Application Publication
(10) Pub. No.: US 2011/0258575 A1
(43) Pub. Date: Oct. 20, 2011

(54) DISPLAYING LARGE DATASETS IN A BROWSER ENVIRONMENT

(75) Inventors: Phil CUPP, Sammamish, WA (US); Peter Richards, Issaquah, WA (US); Dandan He, Redmond, WA (US); Ullatil Shaji, Sammamish, WA (US); Mike Treit, Bellevue, WA (US); Rajiv Poonamalli, Issaquah, WA (US)

(73) Assignee: Microsoft Corporation, Redmond, WA (US)

(21) Appl. No.: 12/761,433

(22) Filed: Apr. 16, 2010

(51) Int. Cl. G06F 3/048; G06F 17/30

(52) U.S. Cl. 715/784; 715/810; 707/769; 707/E17.014; 709/203

(57) ABSTRACT

A mechanism for displaying large datasets may download an approximate range of the dataset along with a subset of the dataset to a client. The client may display the subset as well as indicators for the approximate range. When a user moves to a position within the dataset that is not downloaded, the client may send a request for a second subset of the dataset, which may be displayed on the client. The user may interact with the dataset to select different items in the dataset, for example, and those interactions may be collected while the user views different portions of the dataset. The user may process all of the interactions over the entire dataset or a portion of the dataset by committing the changes.

### BACKGROUND

Many applications may allow a user to view and interact with large datasets. The datasets may be very large and may consume considerable network, memory, and processing bandwidth to download and display.

### SUMMARY

A mechanism for displaying large datasets may download an approximate range of the dataset along with a subset of the dataset to a client. The client may display the subset as well as indicators for the approximate range. When a user moves to a position within the dataset that is not downloaded, the client may send a request for a second subset of the dataset, which may be displayed on the client. The user may interact with the dataset to select different items in the dataset, for example, and those interactions may be collected while the user views different portions of the dataset. The user may process all of the interactions over the entire dataset or a portion of the dataset by committing the changes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing an system that may display large datasets.

FIG. 2 is a timeline illustration of an embodiment showing a method for incremental transmission and display of large datasets.

FIG. 3 is a flowchart illustration of an embodiment showing a method for client operations with a large dataset.

FIG. 4 is a diagram illustration of an example embodiment showing a dataset that may be displayed on a client.

FIG. 5 is a diagram illustration of an example embodiment showing a user interface.

### DETAILED DESCRIPTION

A web service may provide access to large datasets by transmitting only a subset of the dataset to a client device. When a user on the client device attempts to access a portion of the dataset outside of the subset, the client may send a query for another subset to display. The user may perform operations on the dataset such as selecting individual elements or the entire dataset, and the selected items may be transmitted to the web service for processing.

The client may receive the approximate or actual bounds of the dataset in an initial query, along with a subset to display. The client may present a user interface to a user that shows at least some of the elements in the subset, as well as indicators for the approximate size of the dataset. The size of the dataset may be such that the entire dataset may not be shown on a single user interface and the user may scroll or otherwise navigate through the dataset. As the user scrolls or moves through the dataset, the user interface may display the subset of elements or placeholders for elements when those elements are not downloaded from the web service. When the user stops scrolling, the client may request another subset from the dataset and may populate the user interface.

The mechanism for navigating and displaying the dataset may allow a user to view and manipulate the entire dataset without having to download the entire dataset at once. Because only a portion of the dataset is downloaded at a time, the dataset may be displayed quickly, yet the user may still be given access to the entire dataset.

The web service may receive a request for the dataset, which may come in the form of a request for a web page through which the dataset may be viewed. The web service may generate the Hyper Text Markup Language (HTML) web page along with representations for a subset of the elements in the dataset. The web page may also include an approximate or actual size of the entire dataset. The client may create a user interface mechanism that represents the overall size of the dataset, then may populate the elements in the dataset with the subset that may be contained in the web page. When the user moves to a location within the interface mechanism where the dataset elements are not populated, the client may initiate a request for another subset of the dataset.

As the client receives the subsets of the dataset, the client may populate a local cache that contains the downloaded portions. The user may select various elements in the cache on which an operation may be performed. The selected elements may be stored in the cache and transmitted to the web service as part of a request to perform an action.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

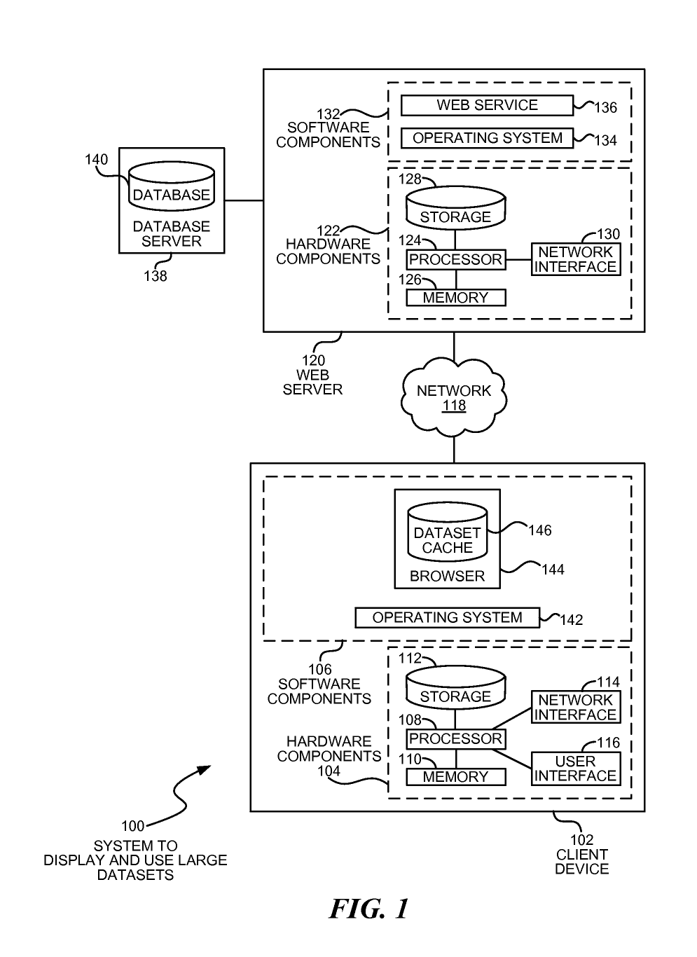

FIG. 1 is a diagram of an embodiment 100, showing a client and server system for displaying a large dataset. Embodiment 100 is a simplified example of a browser on a client that may request and display a large dataset by receiving a subset of the dataset along with an actual or approximate size of the dataset.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 may represent a conventional web browser and web service configuration. A client device may have a browser or other application that may display elements from a large dataset, and a web server may respond with a web page and a subset of the dataset. The client may present the portion in a manner that may communicate the overall size of the dataset to the user. When the user navigates to a location in the dataset for which elements are not stored on the client, the client may request additional subsets of the dataset from the web server and populate the user interface.

A client device 102 may represent any device that may operate an application that may reference and display a large dataset. In many cases, such an application may be a web browser, although other applications may also be used.

The client device 102 may be a conventional computing device, such as a personal computer or server computer. In some embodiments, the client device 102 may be a game console, kiosk, personal computer, or network appliance. The client device 102 may be a portable device, such as a laptop computer, netbook computer, cellular telephone, hand held scanner device, Global Positioning System (GPS) navigation device, personal digital assistant, portable music or video player, or any other type of device that may perform the functions described.

The client device 102 may have a set of hardware components 104 and software components 106. The hardware and software architecture described in an example architecture that may represent a common architecture for computing devices.

The hardware components 104 may include a processor 108, random access memory 110 and nonvolatile storage 112. The hardware components 104 may also include a network interface 114 and a user interface 116.

The software components 106 may include an operating system 142 on which an application such as a browser 144 may operate. The browser 144 may have a dataset cache 146, which may contain data downloaded from a web server and displayed in the browser 144.

The client device 102 may connect to a network 118 and to a web server 120. The network 118 may be a wide area network, a local area network, or a combination of local area network with a gateway or bridge to a wide area network.

The web server 120 may respond to Hyper Text Transmit Protocol (HTTP) requests and transmit HTTP responses with the browser 144. Such requests and responses are often in the form of Hyper Text Markup Language (HTML) documents, which may be rendered and displayed by the browser 144. In some cases, the web server 120 may transmit various scripts or other executables embedded in the HTML documents.

The web server 120 may have a set of hardware components 122 that are similar to the hardware components 104 of the client device 102. The web server's hardware components 122 may include a processor 124, random access memory 126, and nonvolatile storage 128. The web server may include a network interface 130.

The web server 120 may have a set of software components 132 that may include an operating system 134 and a web service 136.

The example of embodiment 100 illustrates that web server 120 as a standalone device, which may be a server device. In other embodiments, the web service 136 may be performed by a cluster of servers where multiple servers may appear to the client device 102 as a single web server but may have multiple redundant hardware platforms for fault tolerance and load balancing. In some embodiments, the web service 136 may be a service that operates on a cloud computing platform, which may execute in a datacenter with tens of thousands of hardware platforms.

The web service 136 may communicate with a database server 138 that has a database 140. The database server 138 may be illustrated as a separate hardware platform, but in other embodiments, the database 140 may be operable on the web server 120 or the database 140 may be provided through a cloud based computing platform.

Embodiment 100 illustrates a use scenario for a browser that may display a subset of a large dataset. In other embodiments, the same operations may be performed with a client application communicating with a server application. For example, the client application may be an email application that communicates with an email server. The email server may transmit partial sets of an email dataset to be displayed by the email application using the same techniques discussed in this specification and applied to the email client and server system.

In an embodiment that may use a web browser, the web service 136 may transmit a set of scripts or other executable commands within a web page that may perform actions such as querying the web service 136 for additional portions of a dataset to display, as well as other interactions between the browser 144 and the web service 136 while a user interacts with the displayed dataset.

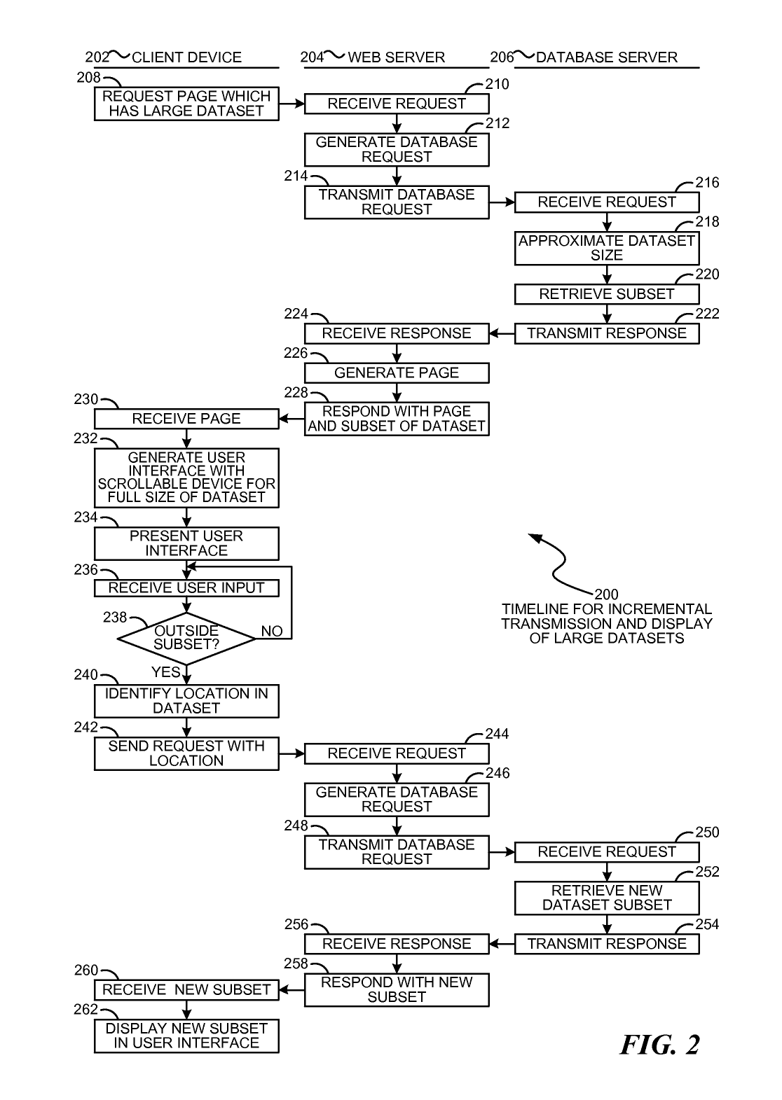

FIG. 2 is a timeline illustration of an embodiment 200 showing a sequence of interchanges between a client device, web server, and a database server. Embodiment 200 is an example of interactions between the respective devices, which may represent the client device 102, web server 120, and database server 138 of embodiment 100. The operations of a client device 202 are illustrated in the left hand column, the operations of a web server 204 are illustrated in the center column, and the operations of a database server 206 are illustrated in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The operations of embodiment 200 illustrate how a client device may request a large dataset and may receive a subset of the dataset, along with the approximate extents of the dataset, to generate a user interface that appears to be fully populated. As a user browses, scrolls, or otherwise moves within the dataset, the client may request additional subsets of the dataset to display.

The interactions of the various components in embodiment 200 illustrate how very large datasets may be managed on a client device. A more detailed illustration of the actions performed by a client device is presented in embodiment 300 presented later in this specification.

A client device 202 may request a page that has a large dataset in block 208. The page may be a webpage in the case of a web browser, or may be a user interface that contains a large dataset in the case of another type of application. The large dataset may be a dataset that is larger than would fit on a screen or physical user interface.

In many cases, the requested page may have some interactive mechanism by which a user may perform operations on one or more of the items in the dataset. In some cases, the user may select all items in the dataset and perform an operation. In other cases, the user may select individual items or groups of items from the user interface and perform an operation on the selected items.

In one use scenario, the requested page may be a web page that may reference a large dataset. For example, a web-based email system may send a request for a web page to display a long list of email messages. Because the list of email messages may be much larger than the physical screen on which the messages may be displayed, the web page may be displayed with a vertical scroll bar that may allow a user to scroll through the list of email messages.

Rather than downloading the entire list of email messages, the server may transmit a subset of the list, plus the list extents. The client device may arrange the user interface using the list extents, but may only display the subset that was downloaded. When the user moved to a location within the dataset that is not stored in the client's memory, the client may request additional data, which may be downloaded and displayed in the same user interface.

A similar use scenario may be performed when a client application in a client-server arrangement. A client-server arrangement may be part of a computer management system that may display a large number of events from an event log, for example. The client may request the event log information, and may configure the user interface to display the entire event log. The server may transmit a small portion of the event log to the client. As the user scrolls through the data, additional requests may be made to the server to requests more data.

In both use scenarios, a user may be able to manipulate or work with the items in the dataset. For example, a user may select individual items by toggling a checkbox for individual items as the user scrolls through the data. The selected items may be stored in memory on the client device and may be transmitted to the server when the user selects an operation to perform on the items. In some cases, the user may select all of the items in the dataset, which may include items that have not yet been downloaded, and may perform an operation on all items in the dataset.

The client device 202 may request a page with a large dataset in block 208. The request may be received by the web server 204 in block 210. The web server 204 may generate a database request in block 212 and transmit the request in block 214 to the database server 206. The database server 206 may receive the request in block 216.

In response to the database request received in block 216, the database server 206 may determine an approximate size of the dataset in block 218 and retrieve a first subset in block 220. These items may make up the response transmitted in block 222.

The approximate size of the dataset in block 218 may eventually be used by the client device 202 to create a user interface that indicates the overall size of the dataset. In some embodiments, the size of the dataset may be approximated. For example, some embodiments may count the results up to a certain limit and may return a value that represents a minimum size of the dataset. As an example, an embodiment may count up to 1000 results and return a value of “at least 1000” results. There may be 1001 results or 10,000 results, but in such an example the approximate value may be defined as a minimum upper bound.

The subset retrieved in block 222 may be some number of database results that may be used to start the user interface experience. In some embodiments, the subset may contain a full page of results that may be displayed on a user interface. In other embodiments, the subset may be two or more pages' worth of results. In still other embodiments, the subset may be a fixed number of entries or fixed number of bytes of data. The subset may be selected so that the subset is quickly downloadable to the client device, but large enough that the user may begin to interact with the dataset.

The web server 204 may receive the response in block 224, generate the page to display in block 226, and respond to the client device 202 in block 228 with the page definition, the page extents, and the subset of the dataset.

The client device 202 may receive the response in block 230 and generate a user interface with a scrollable device to display the dataset. The scrollable device may be a scroll box that has a bar or thumb that may be dragged to position the view of the dataset. The bar or thumb may also be known as an elevator, quint, puck, wiper, or grip. The bar or thumb may be positioned in a ‘trough’. A user may click in the trough to move the bar or thumb a full page.

The relative size of the bar or thumb to the trough may give the user an indication of the size of the overall dataset. The relative position of the thumb within the trough may give a visual indication of the position of the displayed elements within the dataset. Other embodiments may use different scrollable or navigating devices.

The user interface may be presented to a user in block 234. The user may interact with the user interface in block 236. If the user interactions are within the subset in block 238, the process may loop back to block 236. If the user interactions are outside the subset in block 238, a location for another subset may be identified in block 240 and a request for another subset may be transmitted in block 242.

The location defined in block 240 may be the location from which another subset may be requested. For example, a user may grab a thumb in a scroll bar and move the thumb to the midpoint of a dataset that has 10,000 elements. In such an example, the location may be determined as starting at location 5000.

The web server 204 may receive the request in block 244, generate another database request in block 246, and transmit the database request in block 248. The database server 206 may receive the request in block 250, retrieve a new subset in block 252, and transmit the response in block 254.

In some cases where the upper bound of the dataset is approximated, a second request for a subset may cause the upper bound to be refined or changed. Using an example above, the upper bound of the dataset may be cut off at 1000 items for an initial approximation. During a subsequent request for additional subsets of data, the upper bound may be determined to be at least 2000 items. The updated upper bound may be returned with the additional subset.

The web server 204 may receive the response in block 256 and respond to the client device 202 in block 258. The client device 202 may receive the new subset in block 260 and display the new subset in block 262 in the same user interface as in block 234.

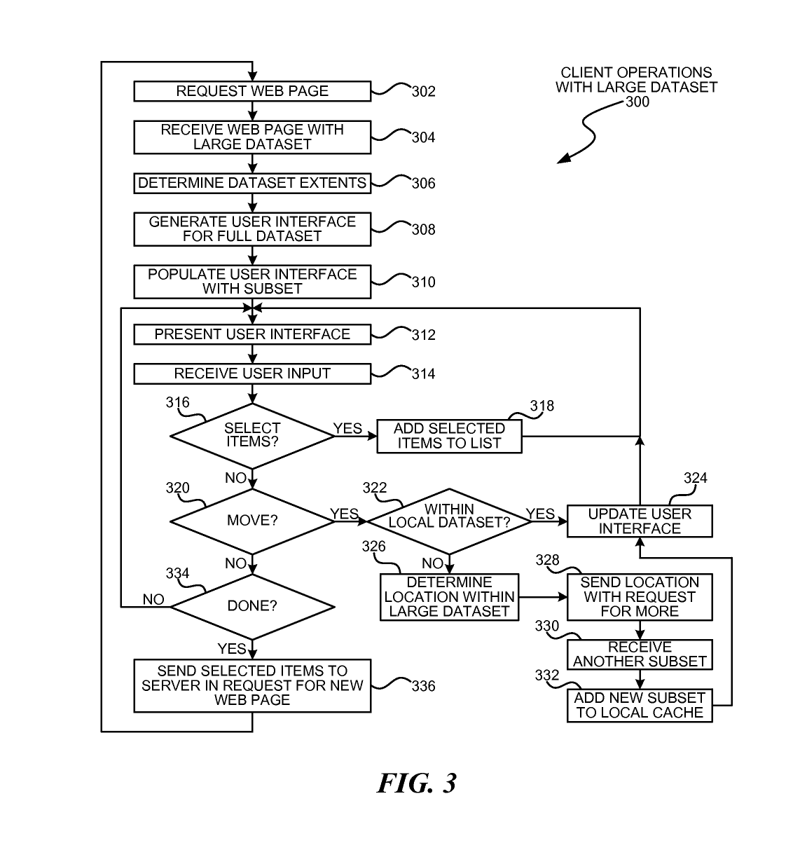

FIG. 3 is a flowchart illustration of an embodiment 300 showing a method that may be performed by a client device when handling large datasets. The operations of embodiment 300 may be a more detailed example of operations performed by the client device 102 of embodiment 100 or the client device 202 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates one manner in which a client device may process information provided by a web server. The web server may transmit the extents of a dataset along with a subset. The subset may be displayed to the user, and the user may manipulate the subset. When the user moves to a location that is not covered by the subset, another subset may be requested from the server.

While the user scrolls through and browses the dataset, the user may select items within the dataset. In some embodiments, the user may toggle a checkbox or other indicator for an element in the dataset. Other embodiments may allow the user to select individual elements using a control-click operation or a shift-select operation with a pointing device.

As the user selects items, those items may be stored by the client device. At some point, the user may identify an operation to perform on the items, and the list of items may be transmitted to the server at that point.

In the example of embodiment 300, the page requested from the server is a web page. In other embodiments, another type of page or data request may be made.

The client may request a web page in block 302 and may receive the web page for a large dataset in block 304. In block 306, the extents of the dataset may be determined. The extents may be included in the response received in block 304.

A user interface may be generated in block 308 with the extents of the full dataset. The extents may give visual indicators to the user of the approximate or exact overall size of the dataset, and may include graphical and textual indicators. An example of a graphical indicator may be the relative size of a thumb in a scroll bar. An example of textual descriptions may be an indicator that may say “displaying items 1-10 of 1000” or some other indicator.

The user interface mechanism may be populated by items from the subset in block 310 and the user interface may be presented to a user in block 312. User input may be received in block 314. If the user input included selecting one or more items from the subset in block 316, the selected items may be added to a list in block 318. The process may then return to block 312.

If the user performs a move in block 320 and the move is within the subset of items stored on the client in block 322, the user interface may be updated in block 324 and returned to block 312.

If the user performs a move in block 320 and the move is outside the subset of items stored on the client in block 322, a location within the dataset may be determined in block 326 and transmitted to the server in block 328. Another subset may be received in block 330 and the new subset may be added to the local cache of the dataset in block 332. The process may update the user interface in block 324 and then return to block 312.

As the user moves from one area of the dataset to another, additional subsets of data may be downloaded. The subsets may be maintained within a local cache so that the user may scroll back to a previous location and the cached items may be displayed, along with any selections the user may have made.

If the user is not done selecting items in block 334, the process may loop back to block 312. When the user is done in block 334, the selected items may be sent to the server in block 336 along with a selection for a command to process the items.

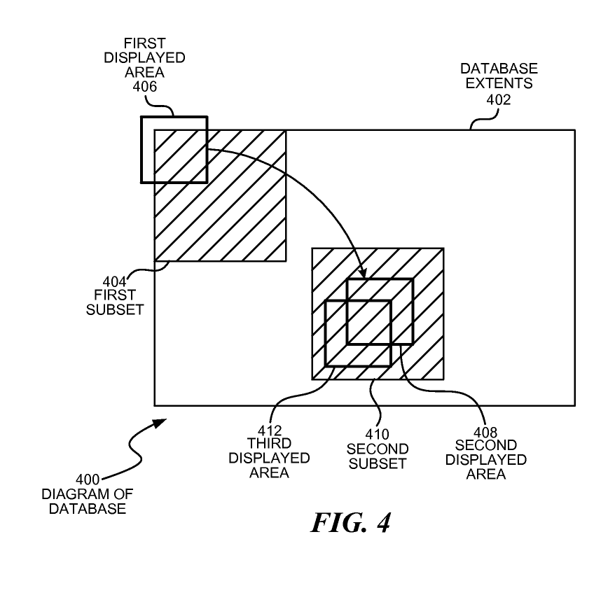

FIG. 4 is an example diagram illustrating embodiment 400 showing a dataset and the displayed area and subsets that may be downloaded by a client device.

Embodiment 400 is a pictorial illustration of the concepts of scrolling through a large dataset when downloading and displaying subsets of the large dataset. Embodiment 400 illustrates the large dataset as a two dimensional dataset. In many embodiments, the dataset may be a single dimensional dataset, such as a list. In other embodiments, such as embodiment 400, the dataset may be a two dimensional dataset that the user may scroll through or navigate using two dimensions.

When the dataset is initially provided to the client, a first subset 404 may be downloaded. The first subset 404 may be larger than the first displayed area 406 so that the user may be able to scroll a little way and experience the user interface as if the entire dataset were loaded.

If the user were to navigate to a middle location in the dataset, a second subset 410 may be downloaded and the user may view a second displayed area 408. The user may be able to move around the second subset 410 and view a third displayed area 412. The third displayed area 412 may be within the second subset 410 so that the client may not request another subset.

As each subset is downloaded, the subsets may be stored in a local cache. The local cache may store each item along with the user's selections or manipulations of the items. As the user navigates to more areas of the dataset, more and more subsets may be downloaded until all of the items in the dataset may be downloaded.

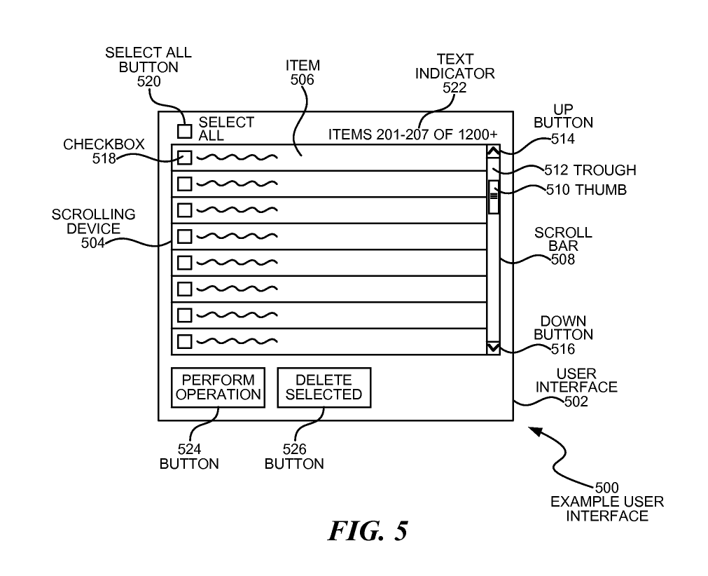

FIG. 5 is an example diagram illustration of an embodiment 500 showing a user interface. Embodiment 500 may be a user interface of a web page presented in a web browser, or a user interface provided by an application in a client server system.

A user interface 502 may have scrolling device 504 that may present a large dataset. The scrolling device 504 may have a scroll bar 508 that may include a thumb 510 in a trough 512. The relative size of the thumb 510 to the trough 512 may be a visual or graphic indicator about the overall size of the dataset, even though a subset of the dataset is available locally.

The scroll bar 508 may also include an up button 514 and down button 516. A user may move up or down to scroll through the items 506 by pressing the up button 514 or down button 516, respectively. In many embodiments, a user may scroll up or down continually by holding down the respective up or down button. Many embodiments may allow a user to scroll rapidly by holding the thumb 510 and moving the thumb 510 to another location within the trough 512.

In many embodiments where a user may scroll rapidly, the user interface 502 may display an animated indication of scrolling but may not request an updated subset until the user stops scrolling.

A user may be able to select or manipulate items from the dataset in several different manners. Each item 506 has a checkbox 518 by which the user may indicate individual items. The select all button 520 may allow the user to select or toggle all items in the dataset. When the select all button 520 is activated, the user may be able to select items in the dataset that are not downloaded and displayed.

Once one or more of the items are selected, the buttons 524 and 526 may cause the selected items to be sent to the server for processing. Button 524 may perform a designated operation and button 526 may delete the selected items from the dataset.

Some embodiments may include a text indicator 522 that may display the current location within the dataset. In the case where the maximum bound of the dataset has not been determined, the minimum upper bound may be displayed with an indicator that additional items may be available. In the example of text indicator 522, the text states: “Items 201-207 of 1200+”. The “+” indicator may indicate that additional items may be available.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor by a client device, said method comprising:
receiving a first user request for a web page from a user;
transmitting a first web service request to a web service;
receiving a response from said web service, said response comprising:
a range definition for a dataset to display; and
a first subset of said dataset;
displaying a scrollable display for said dataset, said scrollable display displaying at least one indicator for said range definition and at least a portion of said subset.

2. The method of claim 1 further comprising:
receiving a user request for a first portion of said dataset, said first portion being outside said first subset;
transmitting a second web service request to said web service a second subset of said dataset;
receiving said second subset from said web service;
displaying at least a portion of said second subset.

3. The method of claim 2 said second web service request comprising an index for a last displayed item in said dataset, said second subset being determined from said last displayed item.

4. The method of claim 3, said last displayed item being outside of said first subset.

5. The method of claim 4, said last displayed item having been removed from said dataset since said receiving said web response.

6. The method of claim 2 further comprising:
receiving user selections comprising:
at least one selection from said first subset; and
at least one selection from said second subset; and
transmitting said user selections to said web service.

7. The method of claim 6, said user selections comprising selecting all of said dataset.

8. The method of claim 1, said range definition being an approximate range definition.

9. The method of claim 8, said range definition comprising a minimum upper bound.

10. A system comprising:
a web service;
a connection to a database;
said web service that:
receives a first request for a web page from a client device, said web page comprising a display of a large dataset;
transmits a first request to a database for a range definition for said large dataset and for a first subset of said large dataset;
receives said range definition and said first subset; and
transmits a first response to said client device, said response comprising said range definition and said first subset.

11. The system of claim 10, said first response further comprising a web page.

12. The system of claim 10, said web service that further:
receives a second request from said client, said second request comprising a location identifier for a member of said large dataset;
transmits a second request to said database comprising said location identifier;
receives a second subset from said database; and
transmits a second response to said client device, said second response comprising said second subset.

13. The system of claim 12, said web service that further:
receives a third request from said client device, said third request comprising a selection comprising a first element from said first subset of said large dataset and a second element from said second subset of said large dataset.

14. The system of claim 13, said third request comprising a selection of all elements in said large dataset.

15. The system of claim 14, said third request being made without transmitting all of said elements in said large dataset to said client.

16. A client device comprising:
a processor;
a user interface;
a web browser that:
transmits a first web service request to a web service;
receives a response from said web service, said response comprising a range definition for a dataset to display, and a first subset of said dataset;
determines a set of extents for a scrollable display;
populates said scrollable display with at least a portion of said first subset;
for at least a portion of said first subset, creates a user interface mechanism capable of receiving user input for an individual element in said subset; and
displays said scrollable display on said user interface.

17. The client device of claim 16, said web browser that further:
receives a user request for a first portion of said dataset, said first portion being outside said first subset;
transmits a second web service request to said web service for a second subset of said dataset; and
receives said second subset from said web service;
displaying at least a portion of said second subset.

18. The client device of claim 17, said response from said web service being a web page comprising said first subset.

19. The client device of claim 18, said web browser that further:
receives user input to rapidly scroll, said user input being to scroll through said first subset and into a portion of said large dataset that is not cached on said client device;
while said user input is being received, generating an animated scrolling indicator until said user input stops; and
when said user input stops, transmitting said second user request.

20. The client device of claim 19, said web browser that further:
when said user input stops, determining a location within said large dataset based on said user input.
